(19) United States
(12) Patent Application Publication
(10) Pub. No.: US 2024/0185121 A1
(43) Pub. Date: Jun. 6, 2024

(54) PLATFORM FOR DELIVERING DATA-CENTRIC MACHINE LEARNING SOLUTIONS

(71) Applicant: MODULOS AG, Zurich (CH)

(72) Inventors: Kevin SCHAWINSKI, Zurich (CH); Anna WEIGEL, Zurich (CH); Claudio BRUDERER, Zurich (CH); Romain LENCOU, Zurich (CH); Maximilian Dennis TURP, Zurich (CH); Dominic STARK, Zurich (CH); Michael RÖTHLISBERGER, Zurich (CH)

(73) Assignee: MODULOS AG, Zurich (CH)

(21) Appl. No.: 18/076,285

(22) Filed: Dec. 6, 2022

(51) Int. Cl. G06N 20/00; G06F 3/04842

(52) U.S. Cl. CPC G06N 20/00; G06F 3/04842

(57) ABSTRACT

The invention is notably directed to a computer-implemented method of assisting users in improving training datasets and obtaining machine learning (ML) solutions. The method comprises the following steps, which are performed at a computing platform. First, the method loads a training dataset selected by a user. The training dataset contains labelled samples. Second, one or more ML solutions are trained on the loaded training dataset, in accordance with an objective function. Next, the computing platform receives a user selection of a given ML solution from the one or more trained ML solutions, as well as an improvement objective. Note, in practice, the method typically trains several ML solutions, initially, whereby the given ML solution is selected from the several ML solutions trained. The method subsequently determines, in the training dataset, one or more defective samples that impair the given ML solution, according to (i.e., in view of) the improvement objective. This leads the user to modify the training dataset by resolving at least one of the one or more defective samples. The given ML solution is finally retrained on the modified training dataset, in accordance with said objective function, to obtain a revised ML solution. The invention is further directed to related computerized systems and computer program products.

### TECHNICAL FIELD

The invention relates in general to the field of computer-implemented methods, computer systems, and computer program products, for assisting users to obtain machine learning (ML) solutions. In particular, the invention is directed to methods involving a computing platform, which allows users to upload a training dataset, train ML solutions on such a dataset, select a given ML solution together with an improvement objective, determine defective training samples that impair the selected ML solution as per the improvement objective, accordingly modify the training dataset by resolving the defective samples, and retrain the selected ML solution on the modified training dataset.

### BACKGROUND

Machine learning concerns cognitive techniques that allow computerized systems to learn from input data. Machine learning sometimes involves artificial neural networks (ANNs), which are computational models inspired by biological neural networks in human or animal brains. Such systems progressively and autonomously learn tasks by means of examples: they have successfully been applied to speech recognition, text processing, and computer vision, amongst many other examples. Several types of neural networks are known, starting with feedforward neural networks, such as multilayer perceptrons, deep neural networks, and convolutional neural networks. Beyond ANNs, a variety of other cognitive models are known, such as decision trees and support-vector machines. Such models are mostly implemented in software executing on conventional computer hardware. However, cognitive models may also be implemented in dedicated hardware, such as resistive processing units (involving crossbar array structures) and optical neuromorphic systems, and/or benefit from hardware acceleration devices involving, e.g., application-specific integrated circuits (ASICs) and/or field-programmable gate arrays (FPGAs).

There are countless ML algorithms, which can possibly be combined. A convenient approach is to decompose ML solutions into feature extractors and cognitive models. A feature extractor branches into a cognitive model. Feature extraction algorithms (sometimes called encoders) allow input data to be converted into arrays (typically vectors). Various extraction methods exist, which allow a variety of digital content to be processed, such as images, sounds (audio files), and text documents. Feature extraction is the process of transforming raw data into numerical features that can then be more convenient processed by the cognitive model. Using a feature extractor upstream of a cognitive model often yields better results than applying a machine learning model directly to the raw data.

The development of ML solutions has traditionally been seen as a sequential and mostly linear process. The first step for users is to gather data, including training data to train the ML solution. This data must typically be cleaned and prepared for training an ML model. This preprocessing step alone is already burdensome, especially for inexperienced users. Next, users must choose, tune, and train suitable ML algorithms to find the best possible ML solution. This step is again difficult, given the myriads of potential algorithms, the fine-tuning of which is more of an art than a science. Finally, this ML solution must typically be evaluated on test data (also called validation data), prior to being deployed. As one understands, the whole process is long and tedious, and the result is often uncertain.

### SUMMARY

According to a first aspect, the present invention is embodied as a computer-implemented method of assisting users in improving training datasets and obtaining machine learning (ML) solutions. The method comprises the following steps, which are performed at a computing platform. First, the method loads a training dataset selected by a user. The training dataset contains labelled samples. Second, one or more ML solutions are trained on the loaded training dataset, in accordance with an objective function. Next, the computing platform receives a user selection of a given ML solution from the one or more trained ML solutions, as well as an improvement objective. Note, in practice, the method typically trains several ML solutions, initially, whereby the given ML solution is selected from the several ML solutions trained. The method subsequently determines, in the training dataset, one or more defective samples that impair the given ML solution, according to (i.e., in view of) the improvement objective. This leads the user to modify the training dataset by resolving at least one of the defective samples. The given ML solution is finally retrained on the modified training dataset, in accordance with said objective function, to obtain a revised ML solution.

The present approach relies on a data-centric approach, which allows a user to first train ML solutions and then refine the training data to subsequently improve a selected ML solution. This approach involves interlaced optimization steps, which are alternately performed for the trained ML solutions and the training data, to progressively improve the selected ML solution. Moreover, as the user can rapidly assess the consequences of her/his cleaning actions on the subsequently re-trained ML solution, s/he can afford to gradually improve the training dataset, starting with minimal cleaning actions. I.e., there is no need for the user to decide, ex ante, the extent to which the training data set must be cleaned. So, the present approach help users minimize time spent on cleaning data. This approach departs from traditional approaches to ML, where users first have to clean the training data, prior to training a given ML model.

The steps of determining defective samples (for the user to subsequently modify the training dataset) and retraining the given ML solution can possibly be iterated, until a satisfactory ML solution is achieved. This makes it easier for the user to determine what is the role of each training sample on the eventual performance of the ML solution with respect to improvement objective(s). Interestingly, the method may proactively store a deployment-ready version of any revised ML solution, as in embodiments.

In preferred embodiments, the defective samples are determined by estimating marginal contributions of the labelled samples to a performance of the given ML solution as measured according to the improvement objective, to assess an extent to which each of the labelled samples impairs the given ML solution according to the improvement objective. That is, the same fundamental approach (i.e., based on marginal contributions) can be used in respect of various types of improvement objectives.

Remarkably, in embodiments, the method further determines, for each of the defective samples, which of a corresponding sample input data and a corresponding label needs to be resolved, it being noted that each training sample is eventually processed as a construct associating some input data with a label. This is preferably achieved by executing an outlier detection method, complementarily to estimating the marginal contributions.

The defective samples are advantageously determined by ranking the labelled samples in accordance with an extent to which such samples impair the given ML solution according to the improvement objective. E.g., the method may identify a subset of the ranked labelled samples that impair the given ML solution most and return the identified subset to the user for the latter to resolve one or more defective samples in the identified subset.

The determination of the defective samples may actually involve several data quality assessment modules, the latter including an influence function computation module and/or a Shapley value computation module, each designed to compute marginal contributions of the labelled samples to the improvement objective, as discussed above. In addition, the data quality assessment modules may involve an outlier detection module and/or a missing label identification module.

Each of the above ML solutions is preferably devised as a combination of a feature extractor and a cognitive model. Not only this benefits to the performance of ML solutions but, in addition, this makes it easier for users to configure the potential ML solutions. The feature extractor is designed to extract features from the input data of a training sample or as an array of numbers (e.g., a vector). The combination is formed by branching the feature extractor into the cognitive model for the latter to process said array of numbers. In particular, the method may possibly determine, automatically, combinations of feature extractors and cognitive models that are compatible with the loaded training dataset and a type of inference to be performed. This is achieved by determining: (i) feature extractors that are compatible with the loaded training dataset: and (ii) cognitive models that are compatible with the determined feature extractors and the type of inference to be performed.

The method preferably runs a graphical user interface (GUI) to enable (and ease) interactions with the user. In particular, the user may use the GUI to select and/or upload the training dataset, select the given ML solution and the improvement objective, modify the training dataset, and export the revised ML solution. What is more, the identified subset may advantageously be returned to the user by displaying the ranked labelled samples as selectable items. The GUI may notably be designed to run an assistant upon the user selecting any of the items, the assistant proposing a menu with user selectable actions to resolve any defective sample.

In embodiments, the method proactively generate deployment-ready versions of the ML solutions. For example, after retraining the given ML solution, the method may obtain a deployment-ready version of the revised ML solution and display the revised ML solution to the user, via the GUI, the GUI being otherwise designed to allow the user to export the deployment-ready version of the revised ML solution from the platform. In fact, the method preferably obtains deployment-ready versions of any of the trained ML solutions and displays, via the GUI, the trained ML solutions to the user as selectable items. In that case, the GUI is designed to allow the user to export a deployment-ready version of any trained ML solution, in accordance with any selected one of the items. To that aim, the GUI may advantageously be operatively connected to a RESTful web API (also known as REST API).

The method typically prompts the user to upload the training dataset, initially. Interestingly, the method may advantageously rely on the use of a dataset structure file (DSSF) providing indications as to the structure and formats of files encompassing the training dataset, to allow more flexibly. Namely, the training data further contains a DSSF, a base form of which is a list of dictionaries, such that each component of the training dataset is represented by one dictionary. Each dictionary describes properties of a respective component. This makes it possible to more permissively handle training datasets uploaded by the users.

According to another aspect, the invention is embodied as a computerized system for assisting users in improving training datasets and obtaining ML solutions. Consistently with the first aspect of the invention, the computerized system is configured to: load a training dataset of labelled samples selected by a user: train one or more ML solutions on the loaded training dataset, in accordance with an objective function: receive a user selection of a given ML solution from the one or more trained ML solutions and an improvement objective; determine, in the training dataset, one or more defective samples that impair the given ML solution according to the improvement objective, for the user to modify the training dataset by resolving at least one of the one or more defective samples: and retrain the given ML solution on the modified training dataset, in accordance with said objective function, to obtain a revised ML solution.

Preferably, the computerized system includes a frontend system, a backend system, a database, and a core computation system. The frontend system is configured to run a GUI as part of a web application, to enable interactions with the user. The backend system is connected to the frontend system to enable functionalities of the web application. The database is connected by the backend system, while the core computation system is connected to the backend system via the database. The core computation system is adapted to run core workers in accordance with data stored in the database, to train the one or more ML solutions, determine the one or more defective samples, and retrain the given ML solution.

According to a final aspect, the invention is embodied as a computer program product for assisting users in improving training datasets and obtaining ML solutions. The computer program product comprises a computer readable storage medium having program instructions embodied therewith. The program instructions are executable by processing means of a computerized system to cause the latter to perform steps of a method as described above.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIGS. 1-6 are flowcharts illustrating steps of a method of assisting users in improving training datasets and obtaining machine learning (ML) solutions, as in embodiments. FIG. 1 shows high-level steps, which are detailed in FIGS. 2-6;

FIG. 7 is a diagram illustrating how feature extractors are combined with cognitive models to form a range of potential ML solutions, as in embodiments;

FIG. 8 is another diagram illustrating how training examples can be ranked with respect to improvement objectives by various data quality assessment modules (DQMs), as in embodiments:

FIG. 9 schematically represents a computing platform that can be configured as a server (on-premises) or as a cloud instance, and involving several core computation workers, as in embodiments:

FIG. 10 schematically depicts a general-purpose computerized system, configured to implement one or more method steps according to embodiments; and

FIG. 11 is a view of a graphical user interface displaying performance indicators of an iteratively improved ML solution, as in embodiments.

The accompanying drawings involved simplified representations of concepts, computerized devices and systems, and parts thereof, as involved in embodiments. Similar or functionally similar elements in the figures have been allocated the same numeral references, unless otherwise indicated.

Computerized systems, methods, and computer program products embodying the present invention will now be described, by way of non-limiting examples.

### DETAILED DESCRIPTION OF EMBODIMENTS OF THE INVENTION

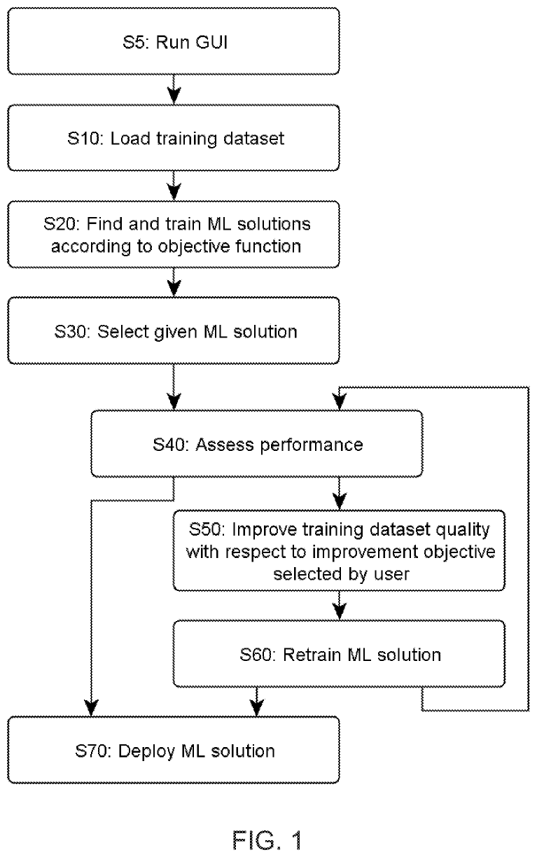

The following description is structured as follows. General embodiments and high-level variants are described in section 1. Section 2 addresses particularly preferred embodiments. Section 3 concerns technical implementation details. Note, the present method and its variants are collectively referred to as the “present methods”. All references Sn refer to methods steps of the flowcharts of FIGS. 1-6, while numeral references pertain to devices and systems, or parts thereof, as well as concepts, involved in embodiments of the present invention.

### 1. General Embodiments and High-Level Variants

### 1.1 Computer-Implemented Methods

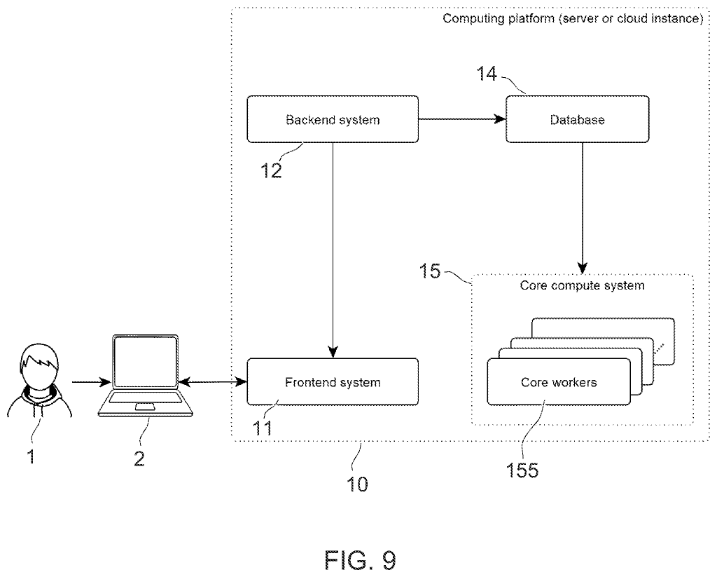

A first aspect of the invention is now described in reference to FIGS. 1-6 and 9. This aspect concerns a computer-implemented method of assisting users in improving training datasets and obtaining machine learning (ML) solutions. This method is implemented by a computing platform 10, which is enabled by a computerized system, see FIG. 9 for an example of implementation. This computerized system itself concerns another aspect of the invention, which is described later in detail.

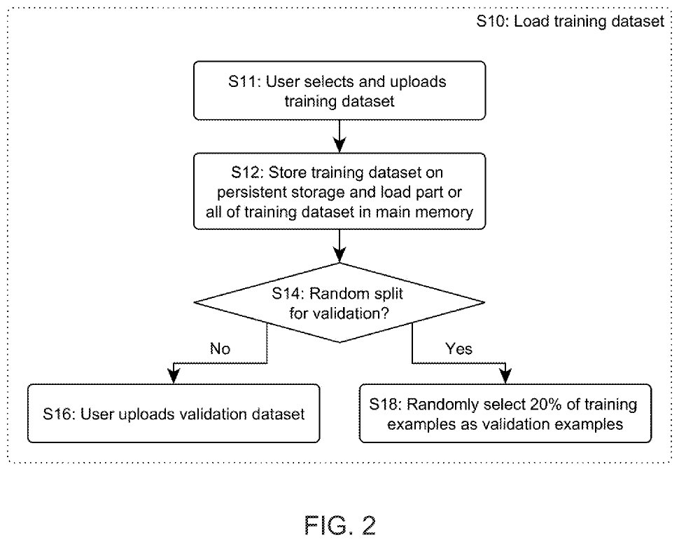

First, the method loads a training dataset of labelled samples (see step S10, FIG. 1), where the training dataset is selected by a user (step S12, FIG. 2). As usual, the training dataset includes training examples, which are typically gathered offline by the user, with a view to training an ML solution. The user may also be given the possibility to select a training dataset made available by or from the platform 10, if necessary. In practice, the selected training dataset may advantageously be uploaded by the user on the platform 10, where it may possibly be stored on a persistent memory of the platform. The training dataset is normally loaded S12 in a main memory of one or more, processing units of the platform (if possible, entirely, else sequentially), with a view to subsequently training ML solutions.

Namely, one or more ML solutions are subsequently trained S20 on the loaded training dataset, in accordance with an objective function. Note, in practice, the method typically trains several ML solutions, initially, as mostly assumed in the following. This, however, depends on the compatibility between, on the one hand, the available ML solutions and, on the other hand, the training dataset and the type of inferences to be performed. The ML solutions will normally be trained in accordance with a same objective function, in order to allow a meaningful selection by the user.

Note, an ML solution preferably is a pipeline combining a feature extractor with a supervised cognitive model, as in embodiments described later in detail. While the feature extractors are typically not trained, the cognitive models must be trained in a supervised manner, based on the labels. Thus, the obtained ML solutions qualify as supervised ML models. Still, the present approach may, in principle, be extended to semi-supervised models.

The initial training S20 operates by optimizing an objective function, e.g., a loss function, a reward function, or the likes. The objective function may have to be minimized, maximized, or otherwise optimized, in respect of part or all of the training dataset. Candidate solutions may then be evaluated against a validation dataset, which may be explicitly provided by the user or automatically generated by the method from the training dataset. While a single objective function is normally used, several objective functions may possibly be considered and iteratively optimized, thanks to known iterative optimization methods, to train the ML solutions.

Next, the platform receives S30, S51 a user selection of a given ML solution from the one or more trained ML solutions, together with an improvement objective, e.g., relating to accuracy or fairness. Note, this improvement objective primarily aims at improving S55 the training dataset itself, rather than the selected ML solution. This, however, indirectly permits to improve S60 the selected ML solution upon retraining it, as discussed later.

The method subsequently determines S53 one or more defective samples in the training dataset. The defective samples are samples that are determined to impair the given ML solution according to the improvement objective. This step causes a further optimization to be achieved, distinct from the optimization performed to train the ML solutions. As per this additional optimization, a measurement is performed S53 for each training sample in respect of the current ML solution, in accordance with the improvement objective, in order to determine one or more defective samples. This is preferably achieved by ranking the training samples in view of the improvement objective, as discussed in detail in Sect. 2.1. The goal is to allow the user 1 to accordingly modify S55 the training dataset by resolving at least one of the defective samples. Note, while this additional optimization S53-S55 is partly automated (step S53 is automated), the user retains control (step S54) over the corrections made.

Eventually, the method retrains S60 the given ML solution on the training dataset as modified S55 by the user. The given ML solution is retrained in accordance with the objective function. This way, a revised ML solution is obtained, which the user may for instance export (e.g., download), with a view to subsequently deploying the revised ML solution.

The above method relies on a data-centric approach, which allows a user to first train ML solutions and then refine the training data to subsequently improve a selected ML solution. This approach requires interlaced optimization steps to be performed with respect to the trained ML solutions and the training data, whereby optimizing the training data improves the final ML solution. Moreover, as the user can rapidly assess the consequences of her/his cleaning actions on the subsequently re-trained ML solution, s/he can afford to gradually improve the training dataset, starting with minimal cleaning actions. This approach departs from traditional approaches to ML, where users first have to clean the training data, prior to training a given ML model. This additional benefit is best understood when one realizes that cleaning actions can possibly take hours or days, while training a model is usually a matter of seconds or minutes, depending on the size of the training dataset.

In detail, a usual approach to ML is for the user to try and manually cure the training data prior to training any ML solution, which is a tedious process. On the contrary, here, the user first trains several ML solutions and only then is invited to improve the training data by resolving defective samples, before retraining the selected ML solution. Thus, there is no need for the user to determine, ex ante, the extent to which the training data set must be cleaned. No cleaning effort is actually required before starting to train ML solutions. Plus, preferred embodiments involve an iterative improvement process, which causes to iteratively improve the training dataset and, thus, the ML solution. This way, the user can obtain a rapid feedback on gradual cleaning actions. As a result, the user can only spend as much time on cleaning as required to reach a sufficient performance. So, the present data-centric approach help users minimize time spent on cleaning data. Typically, a Pareto principle applies, whereby cleaning 20% of the defective samples makes it roughly possible to achieve 80% of the effect of cleaning the entire training dataset.

Various embodiments are discussed herein, which make it possible to accelerates AI delivery, by easing the identification of detrimental training data (e.g., sources of noise and/or bias) that limit the accuracy and/or fairness of the ML solution.

### 1.2 Remarks

Comments are in order. First, all required interactions between the computing platform 10 and external data sources or target system are preferably handled by suitably configured interfaces, which may notably involve hardware and software interfaces, including, e.g., an application programming interface (API) running at the platform 10.

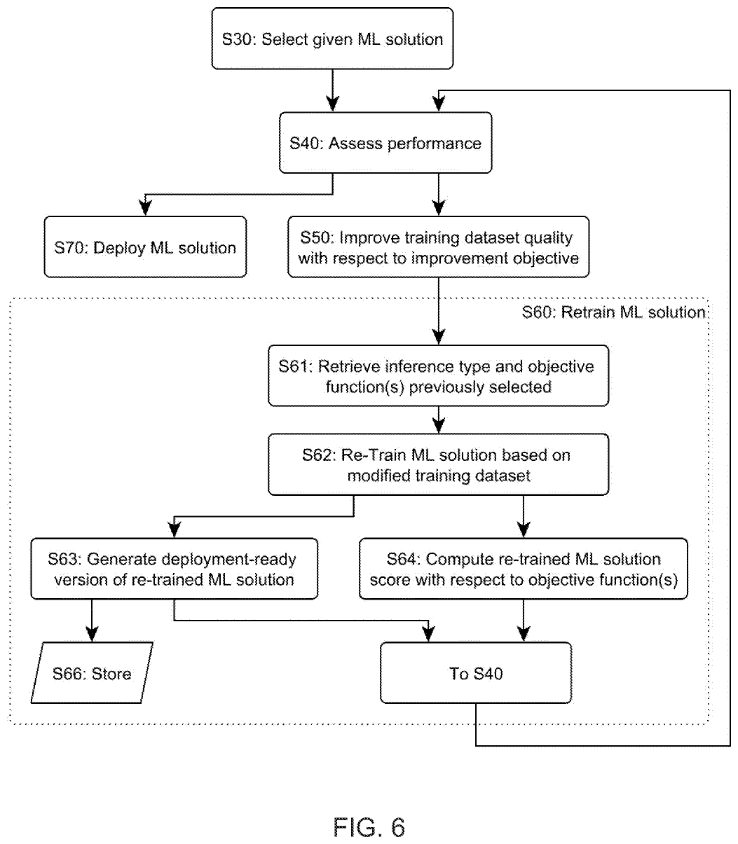

In addition, the above steps involve user interactions that are preferably enabled by a graphical user interface (GUI). That is, the present methods may advantageously comprise, prior to loading S10 the training dataset, running S5 a GUI to enable interactions with the user 1. This way, the user may rely on the GUI to select the training dataset, select the given ML solution and improvement objective, modify the defective samples by resolving defective samples (e.g., by directly editing the defective samples, via the GUI), and eventually export S63 (FIG. 6) the revised ML solution via the GUI. In embodiments, the GUI allows additional types of interactions with the user 1, who may notably upload training datasets, specify how to split this dataset into a training and a validation set, select an objective function to train the ML solutions, and export deployment-ready versions of any of the trained ML solutions.

The type of inferences (i.e., classifications, predictions) to be performed is typically selected by the user too, thanks to the GUI. To that aim, the user may specifically choose a label type, i.e., indicate which data among the training data is to be used as labels. In turn, the selected labels determine the type of inferences to be performed. However, this task may also be automatically performed, should the labels be already identified as such upon uploading the training data. E.g., categorical data advocates a classification task, while a range of numerical values indicate a prediction task.

As evoked above, some or all of the above steps may advantageously be performed iteratively. That is, the steps of determining S53 the defective samples and retraining S60, S62 the given ML solution may possibly be repeatedly performed (see the loop in FIG. 1), for the user 1 to iteratively modify S55 the training dataset, which eventually causes to gradually improve the given ML solution. To that aim, the platform loads any modified version of the training dataset and re-trains the selected ML solution, based on this modified version.

Moreover, the present methods may proactively generate and store S66 a deployment-ready version of any revised ML solution as obtained thanks to this iterative process. That is, the method may store all versions of the gradually improved ML solution. This way, the user can always revert to a previously obtained solution, should it appear to perform better than the last solution obtained. In fact, the present methods may generate and store a deployment-ready version of any of the trained ML solution, should then user want to revert to a previously trained solution.

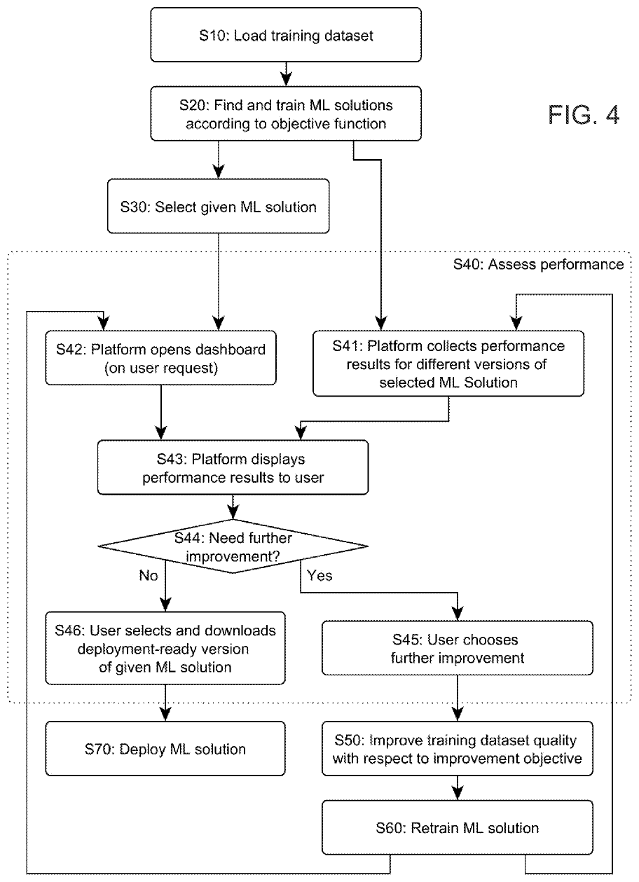

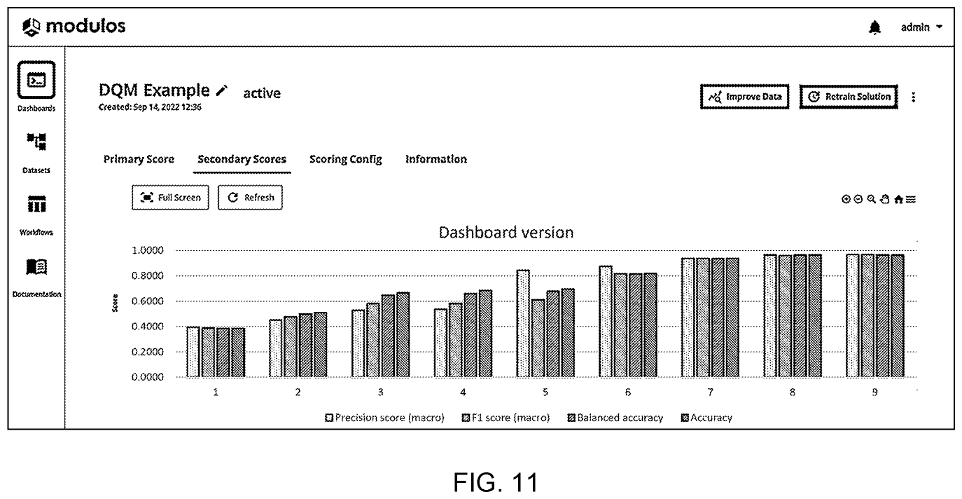

Upon completing the initial training step S20, the performance of the various ML solutions can be evaluated by the user (see steps S41, S43, in FIG. 4). In preferred embodiments, this evaluation is primarily based on the validation dataset. I.e., the present methods preferably focus on validation scores, although secondary performance indicators may be relied upon, which may reflect the performance of the ML solutions with respect to the training dataset too. That is, the performance of the various ML solutions can be evaluated based on several evaluation metrics. E.g., while the primary objective may be accuracy, secondary metrics may be used too, such as the FI score, a precision score, and a balanced accuracy, as assumed in FIG. 11.

The evaluation of the various ML solutions obtained leads the user to select a particular ML solution, together with an improvement objective, the aim of which is to primarily determine defective samples in the training dataset, with a view to improving the training dataset. Still, given that the selected ML solution is eventually retrained based on the improved training dataset, the revised ML solution can itself be regarded as being improved too. Indeed, the properties of the training dataset affect the properties of the revised ML solution. So, by improving the training data, the user improves the ML solution. Note, several improvement objectives may possibly be made available for selection by the user. That is, the present methods may prompt the user 1 to select S51 an improvement objective among several possible improvement objectives, e.g., in terms of accuracy, fairness, outliers, and/or missing labels.

The present methods then automatically determine S53 one or more defective samples among the labelled samples, in view of the selected improvement objective(s). A plurality of defective samples will typically be identified to the user. E.g., a top fraction of the most defective samples are displayed to the user with actionable recommendations. In variants, the method simply ranks the training samples from the most defective to the less defective, without specifically identifying a subset of most defective samples. That a defective sample impairs the given ML solution means that such a sample weakens or even damages the training, as measured in view of the improvement objective(s). Thus, defective samples are samples that typically have a negative impact on the ML solution, as measured with respect to the improvement objective(s). However, those samples that contribute the least to the ML solution performance, as per the same improvement objective(s), may also be identified as defective samples.

Note, a training sample (also called example or training example) is eventually processed as an input-output pair of the form {input data→label}, even though the uploaded training data may initially not explicitly associate pairs of such elements, hence the need for the user to specifically indicate which labels are to be used for training purposes in that case. The input data is sometimes called instance or training instance, datapoint, or feature values. I.e., each sample in the training set is eventually processed as a pair associating some input data with a corresponding label (unless the sample is faulty), where the label is the observed output for this particular input data. Each input data can be a single data element e.g., a single image, a single number, or a list of data elements. In principle, however, an input data may also include more complex constructs, such as associations of data elements or more complex datasets.

The present approach causes to successively perform several optimizations. The ML solutions are first optimized according to an objective function, as with usual ML training processes. However, in the present context, a further optimization is performed in accordance with one or more improvement objectives, which may differ from the optimization objective used to initially train S20 the ML solutions, whereby distinct optimizations are performed at steps S23 and S53-S55. For example, the user may initially choose to optimize the ML solutions for accuracy and then choose to improve the training data set with respect to fairness. The additional optimization S53-S55 is performed in respect to the sole training dataset, in a proactive and data-centric manner, and causes the user to alter those training samples that are determined to impair the ML solution in view of the improvement objective(s) selected. The selected ML solution is eventually re-trained S60, based on the corrected dataset. The various user interactions keep the user in control of the training data, at all times. The present approach notably makes it easier for the user to determine what is the role of each training sample on the eventual performance of the selected ML solution with respect to improvement objective(s) that are specified by her/him.

To summarize, the proposed solution first trains one or more ML solutions for the user to select a given ML solution, then identifies defective training samples in view of an improvement objective selected by her/him, and eventually retrains the selected ML solution based on the corrected training dataset. The proposed approach can thus be regarded as enabling a data-centric AI platform.

### 1.3. Other Aspects of the Invention

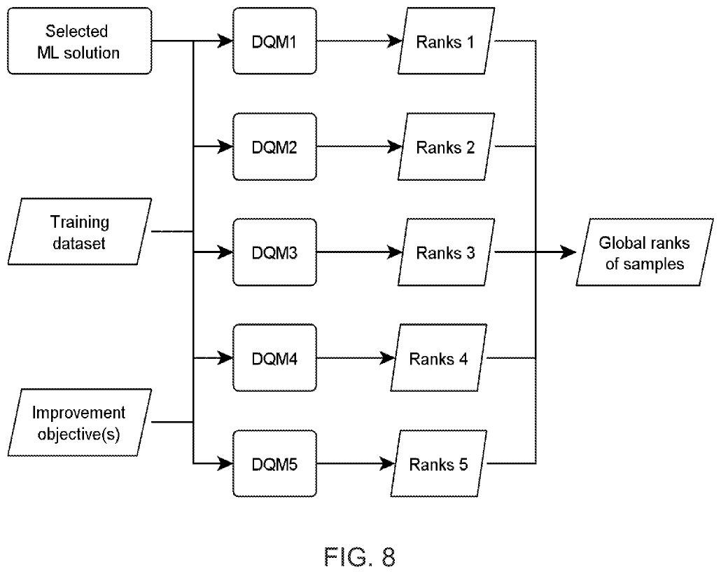

According to another aspect, the invention is embodied as a computerized system 10, 100 such as depicted in FIGS. 8 and 9. As usual, the computerized system 10, 100 includes processing and memory means. The system 10, 100 may notably store computerized methods in the form of software or other executable instructions, which, when loaded and executed by the processing means, configure the computerized system 10, 100 for it to perform steps as described in Sect. 1.1. Namely, once suitably configured, the computerized system 10, 100 can load S10 a training dataset, train S20 ML solutions, receive S30, S51 a user selection of a given ML solution and an improvement objective, determine S53 defective samples that impair the given ML solution as per the improvement objective, for the user 1 to modify S55 the training dataset, and retrain S60 the given ML solution to obtain S63 a revised ML solution.

The computerized system 10, 100 effectively implements a computing platform as described in Sect. 1. The computing platform may notably be embodied as a multi-purpose computer 100, as discussed in Sect. 3.2. In preferred variants, the system is embodied as server, e.g., configured on-premises or as a cloud instance, as discussed in detail in Sect. 3.1.

A final aspect of the invention concerns a computer program product for assisting users in improving training datasets and obtaining ML solutions, or ML solutions. Basically, the computer program product comprises a computer readable storage medium having program instructions embodied therewith. The program instructions are executable by processing means of a computerized system 10, 100 such as discussed above. In operation of the computer system, such program instructions cause the computerized system 10, 100 to perform steps as described in Sect. 1.1. This aspect is discussed in detail in Sect. 3.3

### 2. Preferred Embodiments

Preferred embodiments of the present invention are now described in detail, in respect of computer-implemented methods. However, such embodiments may also be reflected in other aspects of the invention, whether relating to computerized systems or computer program products.

2.1 Identifying Defective Samples Based on their Marginal Contributions to Improvement Objectives

To start with, the defective samples are preferably determined S53 by estimating marginal contributions of the labelled samples to an improvement objective. This makes it possible to assess the extent to which each labelled sample impairs the given ML solution (as selected by the user) according to the improvement objective. Such marginal contributions can notably be estimated by computing Shapley values or influence functions for each training sample. Note, however, that instead of applying an explainability method on a feature level for interpretability or explainability purposes (in the sense of AI explainability), here this is the impact of each training sample that is estimated with respect to the improvement objective, by computing marginal contributions of the training samples toward the improvement objective.

In detail, influence functions are used to approximate the impact on the improvement objective (e.g., accuracy or fairness) that would occur if one were to remove a specific sample from the training dataset. Shapley values are different measurements of the expected marginal contributions of the samples to the improvement objective. In practice, the samples having the most detrimental influence and/or Shapley values can be selected for cleaning as they have contributed the least to, or even have a negative impact on, the model performance. Note, the selected improvement objective may need be maximized (e.g., accuracy) or minimized (e.g., fairness), this depending on the improvement objective selected. So, depending on the selected improvement objective, the most detrimental samples may correspond to those samples having highest or lowest Shapley values.

Such marginal contributions are estimated, meaning that some approximation is used, to keep computations tractable. I.e., the computation of Shapley values uses a K-nearest-neighbor (KNN) model as a proxy model, as well as closed-form computations, to approximate the leave-one-out-loss of each training sample. The Influence function values approximate the leave-one-out-loss of each training sample too, albeit differently. Namely, the computation of influence functions relies on gradients and an approximate form of the hessian matrix of the ML solution (or its cognitive model part). This, in passing, implies that influence functions are only applicable to neural networks. Such approximations are required to maintain tractable computations. Other approaches may similarly be contemplated, provided they make it possible to efficiently estimate the impact of each training sample on the performance, as measured from the viewpoint of the improvement objective.

As noted earlier, each training sample effectively associates some input data with a label. Thus, beyond the mere identification of defective samples, the present methods may further determine S53, for each of the defective samples identified, which of a corresponding sample input data and a corresponding label needs to be resolved. I.e., the underlying algorithm (whether based on, e.g., Shapley values or influence function) can be designed or complemented by some heuristics to discriminate the role of the input data vs. labels, for each training sample. In turn, such information can be provided to users, who may then more efficiently resolve the defective samples.

A particularly efficient approach is to complement the computations of marginal contributions by an outlier detection algorithm. Namely, the present methods may further execute an outlier detection algorithm, complementarily to the computations of marginal contributions, to determine, for each defective sample, which of the corresponding input data and label needs to be resolved. Combined with Shapley or influence values, an outlier detection method provides useful explanations as to the origin of a defective sample. The outlier detection method may for example return a recommendation list of samples that are considered to be outliers based on fitting an isolation forest to the validation dataset features. The lower the outlier score, the more abnormal the sample.

Further data improvement algorithms can be involved (e.g., related to missing labels) to identify defective samples, as discussed later.

### 2.2 Ranking the Training Samples

Defective samples are preferably determined S53 by ranking the labelled samples in accordance with the extent to which they impair the given ML solution with respect to the improvement objective. I.e., the rank of each labelled sample reflects its level of nuisance to the given ML solution according to the improvement objective. A ranked list of samples may thus be returned S54 to the user, via the GUI, for subsequent correction S55.

More practically, only a top fraction of the most detrimental samples may possibly be returned S54 to the user. That is, after ranking the labelled samples, the present methods may identify S53 a subset of the ranked labelled samples that impair the given ML solution most and return S54 the identified subset to the user 1. In turn, the user 1 may focus on this subset and resolve S55 the defective samples it contains. Again, this is preferably achieved via the GUI.

### 2.3 Graphical User Interface (GUI)

The GUI essentially aims at allowing the user 1 to select the training dataset, a given ML solution, and the improvement objective, as well as modify the training dataset by resolving defective samples. In addition, the GUI may be designed so as to allow the user 1 to open an assistant allowing samples to be easily added, deleted, or modified.

For instance, the GUI may display a subset of the most defective labelled samples to the user as selectable items. The GUI may otherwise be designed to run an assistant upon the user selecting any of the displayed items. In that case, the assistant proposes S54 a menu with user selectable actions to resolve S55 any selected sample. Note, defective sample may possibly be individually edited or modified in bulk. E.g., the user 1 may add or delete multiple samples at once or delete all samples having a Shapley value below certain value, for example. Plus, the GUI may further suggest corrected labels, based on features extracted for the datapoints.

The GUI may further be used to export ML solutions, as discussed in the next subsection.

### 2.4 Proactively Generating Deployment-Ready Versions of the Trained ML Solutions

In general, the present methods may generate and store a deployment-ready version of any trained ML solution, so as to make it available to the user via the GUI, as soon as available. In particular, after retraining S62 a given ML solution, the present methods may generate S63 a deployment-ready version thereof and display S43 the revised ML solution to the user 1. The GUI may otherwise be designed to allow the user to export S46 (e.g., download) the deployment-ready version of the revised ML solution from the platform 10.

Since, the improvement process is preferably performed iteratively, this makes it possible to accumulate readily exportable ML solutions. So, at any time during the iterative process, the user may revert to a previously obtained version and immediately export (e.g., download) an available ML solution. The present methods may similarly generate S24 and store deployment-ready versions of all of the ML solutions as initially trained at step S20.

Note, any version of the ML solutions obtained may for instance be displayed S26 to the user (e.g., on request, via the GUI) as selectable items. The GUI will then be designed to allow the user to export S28 a deployment-ready version of a trained ML solution in accordance with any selected item. To that aim, the GUI may advantageously be operatively connected to a RESTful web API.

2.5 Cognitive Models Vs. Feature Extractors

As noted earlier, each potential ML solution is preferably formed as a combination of a feature extractor and a cognitive model. The feature extractor extracts features from input data as an array of numbers and branches into the cognitive model. The latter accordingly processes such arrays of numbers, whether to form inferences (predictions, classification) or learn its own parameters (on training). I.e., the cognitive model uses outputs from the feature extractor as inputs. In detail, during the training, features are extracted from the input data of the samples and fed as inputs to the cognitive model, for the cognitive model to learn its own parameters based on labels of the training samples. After the training, and once the ML solution has been deployed, label-free datapoints (i.e., bare input data) can be extracted and processed for inferencing purposes (e.g., classifications or predictions).

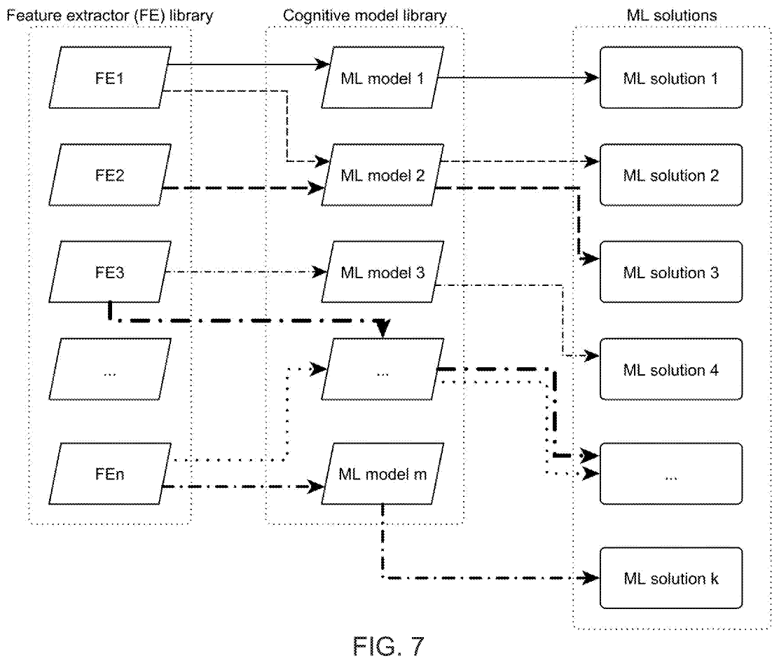

Such a decomposition amounts to decouple the data transformation part from the purely cognitive part, which allows more flexibility and multiple possible combinations of features extractor and cognitive models, see FIG. 7 for an illustration. Note, unlike a cognitive model, a feature extractor does not necessarily need to be trained during the training phase subject to a few exceptions. I.e., feature extractors may have already been suitably trained or otherwise designed or calibrated for extracting features from similar training data types. Thus, only the cognitive model part of the solution needs to be trained for the cognitive model to learn its own parameters in that case. Accordingly, the proposed approach can more efficiently and quickly train an ML solutions.

Note, some feature extractors are regarded as unsupervised ML solutions, which train on the input samples datapoints. However, as an unsupervised mechanism, the feature extraction remains fast. In the present context, one or more (possibly all) of the available feature extractors may use fixed parameters at runtime, which do not require any learning. I.e., such extractors act as fixed encoders.

In embodiments, the present methods automatically determine S22 combinations of feature extractors and cognitive models that are compatible with the loaded training dataset and the type of inference to be performed. This is achieved by first determining feature extractors that are compatible with the type of input data of the samples in the loaded training dataset. Next, the compatible cognitive models are identified. They consist of models that are compatible with the compatible feature extractors and the type of inference to be performed.

Various types of feature extractors may be used, in accordance with each data type. Numeric data may for instance be extracted using discretization, dimension reduction, and/or standardization (e.g., shifting and rescaling elements of lists to have zero mean and unit sample variance). Textual data can for instance be encoded by segmenting the text into characters or words, into a term frequency-inverse document frequency (TFIDF) vector, or using a semantic vectors sequence from the text. Images can be encoded using semantic vectors or based on pixel values. Audio objects can be encoded too, like videos, and many other types of objects.

Similarly, a variety of cognitive model can be relied on for prediction purposes, whether based on decision trees, ensembles of trees (e.g., whether trained with gradient boosting or random decision forests), linear regressions, nearest neighboring examples, artificial neural networks, Gaussian process priors, etc. Similarly, various methods can be used for classification, including methods based on learned distributions, decision trees and ensembles thereof, logistic regressions, Markov models, artificial neural networks, support vector machine, etc.

### 2.6 Data Quality Assessment Modules

Several data quality assessment modules (DQMs) may possibly be made available to the user, who may select one or more of these modules to trigger independent process of determination S53 of defective samples. In particular, the DQMs may include an influence function computation module and/or a Shapley value computation module. As explained earlier, such DQMs are used to compute marginal contributions of the labelled samples to the improvement objective.

As noted earlier too, the DQMs may further include an outlier detection module, which can advantageously be used complementarily to the influence function computation module or the Shapley value computation module to determine the origin of a defective sample (i.e., input data and/or label). For example, this module may return a list of samples considered to be outliers according to an isolation forest fit to the validation dataset features.

Moreover, the DQMs may include a missing label identification module to determine which samples of the training dataset have missing labels. This module may advantageously be completed by a labelling priority module estimating which samples among the unlabeled samples should be labelled, in which order. This module can for instance be devised as a heuristic that prioritize samples having missing labels. E.g., based on the features of unlabeled samples, this heuristic predicts the Shapley values of unlabeled samples, e.g., using a random forest trained on the labelled samples.

As illustrated in FIG. 8, the DQMs may use the (current) training dataset, the improvement objective, and/or the current ML solution (or part thereof), as input. Such inputs are adequately routed to the corresponding modules, as needed for the modules to perform their respective tasks. However, the DQMs may not necessarily need to exploit the three types of inputs listed above. In particular, not all DQMs need to have access to the current ML solution. In the example of FIG. 8, the five DQMs (DQM1, DQM2, DQM3, DQM4, and DQM5) refer to the missing label identification module, outlier detection module, labelling priority module, Shapley values module, and the influence function module, respectively. The missing label identification module works on the training dataset and does not rely on the ML solution. Both the outlier detection module and labelling priority module use outputs from the feature extractor, so that they depend on the ML solution, just like the Shapley values module. However, the influence function module goes one step further as it actually makes use of the actual cognitive model, on top of the feature extractor. So, out of the five DQM modules shown in this example, only the missing label identification module is independent of the ML solution.

The DQMs are independently executed, leading to respective rankings, which may eventually be fused in a global ranking, should several DQMs be concurrently used.

### 2.7 Dataset Structure File (DSSF)

The platform 10 may advantageously be designed to work with a wide range of dataset formats, hence the benefit for the user to add a dataset structure file (DSSF) describing the structure of the training data. Information contained in the DSSF allows more flexibility in the data formats used by the training dataset.

To that aim, the base form of the DSSF may be a list of dictionaries. I.e., each component of the training dataset is represented by a respective dictionary, where each dictionary describes properties of this component. The DSSF may for instance contain one entry for each component of the training dataset and one version key.

A component can for instance be a single table containing information for all samples. A component can also be a collection of files, with one file per sample (e.g., a collection of individual images). In this case, all files must have the same data type and format, and thus contain the same kind of information. The number of components corresponds to the number of distinct files and/or collections of similar files that have to be considered to access all data relevant to the training dataset. Input data can be provided as rows or column, possibly split into several components. Similarly, the labels/outputs can be provided as rows or columns. For example, a first supported scenario is one where input data are split into several components (e.g., the first component is a table including the first 10 columns for all training samples, while the remaining columns form part of a second component). Another scenario is to split input data, whereby, e.g., the first component is a table including all input data pertaining to the first 100 samples, whereas the second component is a table that contains all features for samples 101 to 200.

For each component, the DSSF may include the following information: the component's name, the relative path to the component's files, and type. Different types may be available, e.g., “table”, “str” and “num”, respectively denoting a table, a string, and a numerical format. Plus, the DSSF may include an optional information field, in which the user can specify properties of the components. If this field is left blank, the platform 10 can use heuristics to infer such properties. In other words, the DSSF file gives the user the possibility to describe the structure of the dataset.

For example, the training data may contain a single component, e.g., a .csv table, to which a DSSF is added. The .csv table contains information about all samples. Each components is associated to three mandatory keys (name, path, and type) in the DSSF. Both files may for instance be packaged as a .tar file and uploaded as such to the platform 10 via the GUI. In practice, the present methods typically prompt the user 1 to upload S11 the training dataset, prior to loading S12 the training dataset in the main memory for training purposes and storing it in a persistent storage.

In variants, the training data contain two components. For each sample, one image and one category file are available. Again, both components have the three mandatory keys (name, path, and type) in the added DSSF. The first component contains information on .jpg images. Its type is “num” (for numerical). The path contains a placeholder {id} for the ID of each sample/file. This placeholder is also in the path of the second component. It describes which files belong to the same sample. In addition to the mandatory keys, an optional info key provides further information to the platform. E.g., this can be used to ensure that input data (or part thereof) do not get removed automatically if all the images happen to be identical. The second component contains information about the text files. Its path contains the placeholder for the sample ID as well. Its type is “str” (for string). Here, the optional info key is used to enforce that image classes are categorical.

This way, various dataset configurations to be recognized upon parsing the training files, whereby the platform can flexibly support several formats, with many variants and options.

### 2.8 Preferred Flow

A preferred flow is captured in FIGS. 1-6. The GUI starts running at step S5, FIG. 1, to enable subsequent user interactions. Details of step S10 (loading, FIG. 1) are shown in FIG. 2. The user first uploads S11 a training dataset via the GUI. The training set is typically not curated yet, so that no time is lost by the user here. The uploaded dataset is typically stored on a persistent memory and is further loaded S12 in the main memory of the compute core 15, see FIG. 9. The training dataset may be entirely loaded in the main memory, its size permitting, else it is sequentially loaded, with a view to subsequently training the ML solutions. The user can further choose (S14: No) to upload S16 a validation dataset. Else (S14: Yes), the dataset is automatically partitioned. E.g., 20% of the training samples are randomly selected S18 as validation data from the training dataset.

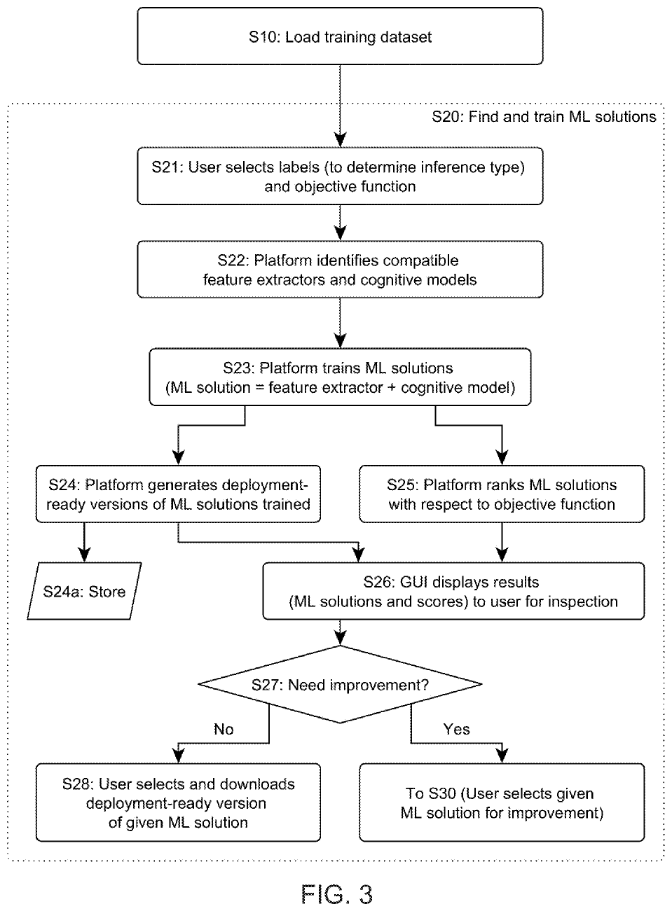

Step S20 (FIG. 1) generally relates to the ML workflow configuration and the training of ML solutions. Details of step S20 are shown in FIG. 3. The user specifies S21 what to infer, e.g., by selecting suitable types of labels as well as an objective function. In variants, the inference type and objective functions are automatically identified based on the training dataset characteristics, or metadata thereof. The user may possibly select various types of feature extractors (FEs) and cognitive models (CMS). Else, suitable FEs and CMs are automatically determined S22 based on the uploaded dataset, as assumed in FIG. 3. The user may nevertheless be given the possibility to deselect some of the identified FEs and CMs. Once the user has configured the workflow, the platform 10 trains S23 various ML solutions (as combinations of FEs and CMs) and ranks S25 them based on scores obtained thanks to any suitable performance metric. Next, the trained ML solutions are readied S24 for deployment. The results are displayed S26 to the user, who can compare the performance of the various ML solutions. The user may consider improving (S27: Yes) one of the ML solutions, see step S30. Alternatively, the user may also be satisfied with one of the ML solutions, as already available (S27: No). In that case, the user selects this ML solution for download and subsequent deployment S70. Note, all ML solutions are preferably stored S24a, in case the user later chooses to revert to one of these ML solutions.

At step S30 (FIG. 1), the user 1 selects one of the trained ML solutions for iteratively improving the training dataset and subsequently re-train the selected ML solution.

Details of step S40 (FIG. 1) are shown in FIG. 4. The platform 10 generates a dashboard, which is opened S42 on user request, whereby information is displayed S43 to the user. The dashboard contains all information relevant to the selected ML solution, such that the user can precisely assess the performance of the trained model. Various scores can be displayed to the user (e.g., primary score and secondary scores), once available. The user can choose (S44: Yes) to improve the currently selected ML solution, which triggers an automatic analysis S50 of the training dataset, with a view to subsequently modifying the training dataset. In turn, the ML solution is retrained at step S60.

At a subsequent iteration (if any), the platform collects S41 updated performance information as to the current ML solution. This updated information is then displayed S43 to the user, who may evaluate the various scores available, including, e.g., the training and validation scores. For example, the primary score may correspond to the objective function chosen during the training workflow configuration to train the ML solutions. The primary score is automatically re-computed at each re-training cycle. Secondary scores may be displayed too. Such secondary scores may be computed on user request and/or include scores stemming from DQM computations. Again, the user may then choose S45 to further improve S50 the current ML solution, should s/he deem it necessary (S44: Yes). Else, if the user is satisfied (S44: No) with the current ML solution, s/he may simply download S46 the current ML solution, once available, with a view to deploying S70 it.

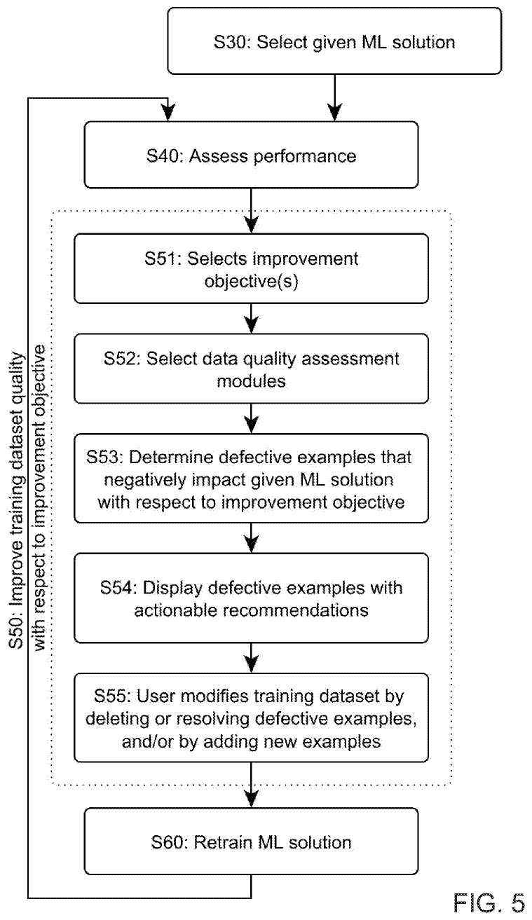

S50 (FIG. 1) generally concerns improvements to the training dataset. Details are shown in FIG. 5. Here the user gets prioritized recommendations S54 on which samples to alter (clean, delete, etc.), in accordance with one or more improvement objectives. That is, the user specifies S51 which aspect to improve, e.g., accuracy, fairness, and/or other general data improvement related to outliers or missing labels. Next, one or more DQMs are accordingly selected S52, automatically, based on the data types, the current ML solution, and the improvement objective(s) selected at step S51. Alternatively, the GUI may select DQMs, by default, and offer the user the possibility to de-select some of the DQMs. The platform 10 subsequently determines S53 which training samples are (most) detrimental to the model performance. For example, the platform displays S54 samples that are ranked in descending order of their negative impact on the improvement objective(s). This can notably be achieved thanks to DQMs that compute marginal contributions to the improvement objective(s), as explained earlier. The displayed results are turned S54 into actionable recommendations to the user, for her/him to debug S55 the training data. In general, the GUI may give the user the possibility to add, delete, or otherwise alter, the training samples. The platform may for instance automatically suggest corrected labels, infer, or interpolate training data input data and corresponding labels, etc. Eventually, a modified training dataset is obtained S55 and stored.

Next, the platform retrains S60 (FIG. 1) the current ML solution, based on the modified training dataset, as illustrated in detail in FIG. 6. To that aim, the platform retrieves S61 all relevant parameters (inference type and objective functions) previously selected and loads the modified training dataset in the main memory of the compute core 15. The current ML solution is re-trained at step S62. A corresponding, deployment-ready version is generated at step S63. All intermediate datasets and cognitive model versions are stored S66 and readied for subsequent deployment, if needed. The scores of the re-trained model are computed at step S64. FIG. 11 shows an example of scores displayed to the user, as obtained along the iterative improvement process. The process then loops back to step S40.

Once the user is satisfied with a given ML solution, s/he may proceed to download a deployment-ready version of this ML solution, via the GUI, with a view to subsequently deploying (step S70, FIG. 1) this ML solution. To that aim, use is made of a RESTFull API. Beside the sole ML solution, various performance indicators can be made available to the user. Typically, the user can choose to either run the exported ML solution natively or in a Docker container.

### 3. Technical Implementation Details

Computerized devices can be suitably designed for implementing embodiments of the present invention. It can be appreciated that the methods described herein are essentially non-interactive, i.e., automated. Such methods are typically implemented as a combination of software and hardware. Sections 3.1 and 3.2 address possible hardware configurations. Section 3.3 specifically concerns computer program products.

### 3.1 Preferred Computing Platform Implementation (FIG. 9)

In preferred embodiments, the computerized system 10 is embodied as server, which may be configured on-premises or as a cloud instance. To that aim, the computerized system 10 includes a frontend system 11, a backend system 12, a database 14, and a core computation system 15, as shown in FIG. 9. The frontend system is configured to run a GUI as part of a web application, to enable and ease interactions with the user 1. The backend system 12 is connected to the frontend system to enable functionalities of the web application. The database 14 is connected by the backend system. The core computation system 15 is connected to the backend system 12 via the database 14. The core computation system 15 is designed to run core workers 155 in accordance with user-defined tasks, to train the ML solutions, determine the defective samples, and retrain the given ML solution. These tasks are stored, managed, and scheduled via the database.

The core workers 155 may for instance correspond to docker containers running the core services. I.e., worker nodes are instances, whose purpose is to execute containers, in accordance with indication stored in the database, which may otherwise act as a persistent storage for the data generated by the user. When using CPU workers, one may for instance allocate at least one CPU per worker, plus two CPUs for the backend, frontend, and database services. In particular, one or more of the core workers may be dedicated for processing tasks that are not related to the (re)training of ML solutions, e.g. the execution of DQM-related tasks. The platform may also be run with GPUs.

Such an architecture makes it easy to install and configure a computing platform 10, whether on-premises or as a cloud instance. The platform 10 may notably be configured to allow users 1 to: (i) work directly via a personal computerized device 2, without requiring any installation or configuration: and (ii) seamlessly upload datasets and download deployment-ready versions of the trained ML solutions.

The computing platform 10 described above may possibly use one or more general-purpose computers as described in Sect. 3.2.

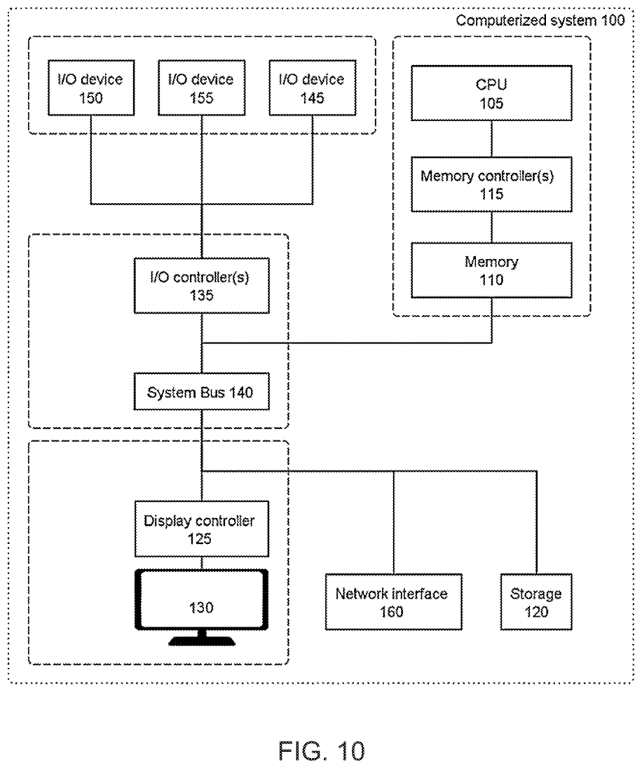

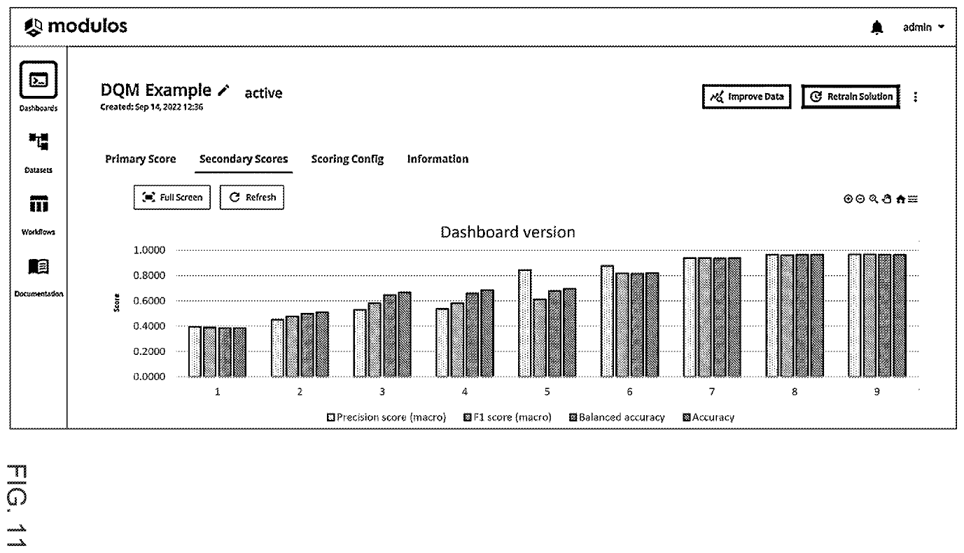

### 3.2 Alternative Implementation Based on General-Purpose Computers (FIG. 10)

In embodiments, the methods described herein are implemented in software, e.g., as one or more executable programs executed by suitable digital processing devices. A suitable computerized system 100 includes one or more processing elements, such as one or more processors 105 and a memory 110 (meant to act as a main memory), coupled to a memory controller 115. The processors 105 are hardware devices for executing software, as loaded in the main memory of the system 100. The processors can be any custom made or commercially available processors: they may include graphics processing unit (GPU), which can be leveraged to perform ML inferences, notably where neural networks are used.

The memory 110 may include a combination of volatile memory elements (e.g., random access memory) and nonvolatile memory elements, e.g., solid-state devices. The software in memory may include one or more separate programs, each of which may for instance comprise an ordered listing of executable instructions for implementing logical functions. In the example of FIG. 10, the software in the memory 110 includes methods described herein in accordance with exemplary embodiments and a suitable operating system (OS). The OS essentially controls the execution of other computer (application) programs and provides scheduling, I/O control, file, data and memory management, and communication control as well as related services.

In embodiments, and in terms of hardware architecture, the system 100 further include one or more input and/or output (I/O) devices 145, 150, 155 (or peripherals) communicatively coupled via a local input/output controller 135. The input/output controller 135 can comprise or connect to one or more buses 140 or other wired or wireless connections. The I/O controller 135 may have additional elements, which are omitted for simplicity, such as controllers, buffers (caches), drivers, and receivers, etc., to enable communications. Further, a local interface may include address, control, and/or data connections to enable appropriate communications among the aforementioned components.

Possibly, a conventional keyboard and mouse can be coupled to the input/output controller 135. I/O devices 145-155 may include other hardware devices, which communicate both inputs and outputs. The system 100 may further include a display controller 125 coupled to a display 130. In exemplary embodiments, the system 100 may further include a network interface 160 or transceiver for coupling to a network (not shown).

The methods described herein shall typically be in the form of executable program, script, or, more generally, executable instructions. In operation, one or more of the processing elements 105 execute software stored within the memory 110 (separate memory elements may possibly be dedicated to each processing element), to communicate data to and from the memory 110, and to generally control operations pursuant to software instructions. The methods described herein, in whole or in part are read by one or more of the processing elements 105, typically buffered therein, and then executed. When the methods described herein are implemented in software, the methods can be stored on any computer readable medium for use by or in connection with any computer related system or method.

Computer readable program instructions described herein can be downloaded to processing elements 105 from a computer readable storage medium, via a network, for example, the Internet and/or a wireless network. A network adapter card or network interface 160 in the device may receive the computer readable program instructions from the network and forwards the program instructions for storage in a computer readable storage medium 120 interfaced with the processing elements.

### 3.3 Computer Program Products

A computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may for example be an electronic storage device, a magnetic storage device, an optical or electromagnetic storage device, a semiconductor storage device, or any suitable combination of the foregoing. Examples of such storage media include: a hard disk, a random-access memory (RAM), a static random-access memory (SRAM), an erasable programmable read-only memory (EPROM or Flash memory), a memory stick, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

### 3.4 Final Remarks

Aspects of the present invention are described herein notably with reference to a flowchart and a block diagram. It will be understood that each block, or combinations of blocks, of the flowchart and the block diagram can be implemented by computer readable program instructions.

These computer readable program instructions may be provided to one or more processing elements as described above, to produce a machine, such that the instructions, which execute via the one or more processing elements create means for implementing the functions or acts specified in the block or blocks of the flowchart and the block diagram. Such program instructions may also be stored in a computer readable storage medium.

The flowchart and the block diagram in the accompanying drawings illustrate the architecture, functionality, and operation of possible implementations of computerized systems, methods of operating it, and computer program products according to various embodiments of the present invention.

Each computer-implemented block in the flowchart or the block diagram may represent a module, or a portion of instructions, which comprises executable instructions for implementing the functions or acts specified therein. In variants, the functions or acts mentioned in the blocks may occur out of the order specified in the figures. For example, two blocks shown in succession may actually be executed in parallel, concurrently, or still in a reverse order, depending on the functions involved and the algorithm optimization used. Furthermore, each block and combinations thereof can also be adequately distributed through special-purpose hardware components.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated.

What is claimed is:

1. A computer-implemented method of assisting users in improving training datasets and obtaining machine learning solutions, or ML solutions, wherein the method comprises, at a computing platform:
loading a training dataset of labelled samples selected by a user;
training one or more ML solutions on the loaded training dataset, in accordance with an objective function;
receiving a user selection of a given ML solution from the one or more trained ML solutions and an improvement objective;
determining, in the training dataset, one or more defective samples that impair the given ML solution according to the improvement objective, for the user to modify the training dataset by resolving at least one of the one or more defective samples; and
retraining the given ML solution on the modified training dataset, in accordance with said objective function, to obtain a revised ML solution.

2. The computer-implemented method according to claim 1, wherein
the one or more defective samples are determined by estimating marginal contributions of the labelled samples to a performance of the given ML solution as measured according to the improvement objective, to assess an extent to which each of the labelled samples impairs the given ML solution according to the improvement objective.

3. The computer-implemented method according to claim 2, wherein
each of the training samples associates an input data with a label, and
determining the one or more defective samples further includes determining, for each of the one or more defective samples, which of the corresponding sample input data and the corresponding label needs to be resolved.

4. The computer-implemented method according to claim 3, wherein
determining the one or more defective samples further includes executing an outlier detection method, complementarily to estimating said marginal contributions, to determine, for each of the one or more defective samples, which of the corresponding input data and the corresponding label needs to be resolved.

5. The computer-implemented method according to claim 2, wherein
the one or more defective samples are determined by ranking the labelled samples in accordance with an extent to which the labelled samples impair the given ML solution according to the improvement objective.

6. The computer-implemented method according to claim 5, wherein the method further comprises, after ranking said each of the labelled samples,
identifying a subset of the ranked labelled samples that impair the given ML solution most, and
returning the identified subset to the user for the latter to resolve one or more defective samples of said identified subset.

7. The computer-implemented method according to claim 1, wherein the method further comprises
running a graphical user interface, or GUI, to enable interactions with the user, whereby the training dataset is selected by the user via the GUI, the user selection of the given ML solution and the improvement objective is received via the GUI, the one or more defective samples are determined for the user to modify the training dataset by resolving said at least one of the one or more defective samples thanks to the GUI, and
exporting the revised ML solution obtained via the GUI.

8. The computer-implemented method according to claim 7, wherein
the identified subset is returned to the user by displaying the ranked labelled samples of the identified subset to the user as selectable items, the GUI being otherwise designed to run an assistant upon the user selecting any of said items, the assistant proposing a menu with user selectable actions to resolve any defective sample.

9. The computer-implemented method according to claim 7, wherein the method further comprises, after retraining the given ML solution,
obtaining a deployment-ready version of the revised ML solution, and
displaying the revised ML solution to the user, via the GUI, the GUI otherwise designed to allow the user to export the deployment-ready version of the revised ML solution from the platform.

10. The computer-implemented method according to claim 9, wherein
the method further comprises, after training the one or more ML solutions and prior to receiving the user selection of the improvement objective and the given ML solution,
obtaining deployment-ready versions of the one or more trained ML solutions, and
displaying, via the GUI, the one or more trained ML solutions to the user as selectable items, the GUI otherwise designed to allow the user to export a deployment-ready version of a trained ML solution in accordance with any selected one of the items.

11. The computer-implemented method according to claim 10, wherein
the GUI is operatively connected to a RESTful web API designed to allow the user to export a deployment-ready version of a trained ML solution upon selecting any corresponding item displayed in the GUI.

12. The computer-implemented method according to claim 1, wherein
each of the training samples associates an input data with a label,
each of the one or more ML solutions trained is a combination of a feature extractor and a cognitive model,
the feature extractor is designed to extract features from said input data as an array of numbers, and
the combination is formed by branching the feature extractor into the cognitive model for the latter to process said array of numbers.

13. The computer-implemented method according to claim 12, wherein
the method further comprises, after loading the training dataset and prior to training the one or more ML solutions, automatically determining combinations of feature extractors and cognitive models that are compatible with the loaded training dataset and a type of inference to be performed, by
determining one or more feature extractors that are compatible with the loaded training dataset, and
determining one or more cognitive models that are compatible with the one or more feature extractors determined and the type of inference to be performed.

14. The computer-implemented method according to claim 1, wherein
the steps of determining the one or more defective samples and retraining the given ML solution are iteratively performed, for the user to iteratively modify the training dataset, and
the method further comprises storing a deployment-ready version of any revised ML solution accordingly obtained.

15. The computer-implemented method according to claim 1, wherein,
the one or more defective samples are determined thanks to several data quality assessment modules, the latter including:
one or each of an influence function computation module and a Shapley value computation module, each designed to compute marginal contributions of the labelled samples to the improvement objective; and
one or each of an outlier detection module and a missing label identification module.

16. The computer-implemented method according to claim 1, wherein
the method further comprises, prior to loading the training dataset, prompting the user to upload training data containing the training dataset and a dataset structure file, wherein
a base form of the dataset structure file is a list of dictionaries, such that each component of the training dataset is represented by one dictionary, and
each of the dictionaries describes properties of a respective one of said components.

17. The computer-implemented method according to claim 1, wherein
training the one or more ML solutions comprises training several ML solutions on the loaded training dataset, in accordance with said objective function, whereby the given ML solution subsequently received is selected by the user from the several ML solutions trained.

18. A computerized system for assisting users in improving training datasets and obtaining machine learning solutions, or ML solutions, wherein the computerized system is configured to:
load a training dataset of labelled samples selected by a user;
train one or more ML solutions on the loaded training dataset, in accordance with an objective function;
receive a user selection of a given ML solution from the one or more trained ML solutions and an improvement objective;
determine, in the training dataset, one or more defective samples that impair the given ML solution according to the improvement objective, for the user to modify the training dataset by resolving at least one of the one or more defective samples; and
retrain the given ML solution on the modified training dataset, in accordance with said objective function, to obtain a revised ML solution.

19. The computerized system according to claim 18, wherein the system includes:
a frontend system, which is configured to run a GUI as part of a web application, to enable interactions with the user;
a backend system, which is connected to the frontend system to enable functionalities of the web application;
a database, which is connected by the backend system; and
a core computation system, which is connected to the backend system via the database, the core computation system adapted to run core workers in accordance with data stored in the database, to train the one or more ML solutions, determine the one or more defective samples, and retrain the given ML solution.

20. A computer program product for assisting users in improving training datasets and obtaining machine learning solutions, or ML solutions, the computer program product comprising a computer readable storage medium having program instructions embodied therewith, the program instructions executable by processing means of a computerized system to cause the latter to:
load a training dataset of labelled samples selected by a user;
train one or more ML solutions on the loaded training dataset, in accordance with an objective function;
receive a user selection of a given ML solution from the one or more trained ML solutions and an improvement objective;
determine, in the training dataset, one or more defective samples that impair the given ML solution according to the improvement objective, for the user to modify the training dataset by resolving at least one of the one or more defective samples; and
retrain the given ML solution on the modified training dataset, in accordance with said objective function, to obtain a revised ML solution.
